(19) United States
(12) Patent Application Publication
(10) Pub. No.: US 2011/0068982 A1
(43) Pub. Date: Mar. 24, 2011

(54) CIRCULARLY POLARIZED ANTENNA AND MANUFACTURING METHOD THEREOF

(76) Inventor: Yuan-Chih LIN, Hsinchu (TW)

(21) Appl. No.: 12/883,711

(22) Filed: Sep. 16, 2010

(30) Foreign Application Priority Data
Sep. 21, 2009 (TW) 98131798

(51) Int. Cl. H01Q 1/38; H01P 11/00

(52) U.S. Cl. 343/700 MS; 29/600

(57) ABSTRACT

A circularly polarized antenna and a manufacturing method thereof. The manufacturing method includes disposing a radiation metal sheet and a ground metal sheet on a top and bottom surfaces of a substrate, respectively, disposing a metal microstrip comprising a first and a second metal microstrip segment on corner regions of the top and bottom surfaces of the substrate and a third metal microstrip segment on a side wall of the substrate, wherein the third metal microstrip segment is electrically connected to the first metal microstrip segment and the second metal microstrip segment, connecting one end of a signal-fed component to a system ground unit, connecting the other end of the signal-fed component to the second metal microstrip segment, and regulating dimensions and locations of the radiation metal sheet, the ground metal sheet, the second metal microstrip segment and/or the first metal microstrip segment so as to optimize signal characteristic of the circularly polarized antenna.

### BACKGROUND OF THE INVENTION

1. Field of the Invention

This disclosure relates to circularly polarized antennas and manufacturing methods thereof, and more particularly, to a circularly polarized antenna having a three-section bended metal microstrip and a manufacturing method thereof.

2. Description of Related Art

Today of increasing mobile communication and wireless network technique, developing new functional application and providing more value-added services for users are only ways to promote industrial development. An application in combination with Global Positioning System (GPS) may be considered as an important technique after Bluetooth technique, wherein the key technique is an antenna technique applicable on Global Positioning System.

The antenna applicable on Global Positioning System in the currently market is usually a microwave dielectric ceramic antenna having electric pins through the ceramic substrate, wherein its signal-fed method is generally a pin-fed method. However, the electric pins on the bottom surface must penetrate holes of a circuit and then the electric pins penetrating the holes are welded on a back surface of the circuit when assembling this kind of microwave dielectric ceramic antenna onto a circuit board, hence consuming time, complicating work, not benefiting massive and rapid assembly and manufacture, increasing overall thickness of products, and reversing product design tendency of light, thin, short, small. Furthermore, since a signal-fed point of this kind of microwave dielectric ceramic antenna is located on a side, its impedance matching is easily interacted with surrounding environment such that stability of signal is affected. Moreover, the microwave dielectric ceramic antenna achieves respectively circular polarization in levorotation and dextrorotation via changing the signal-fed point, hence resulting to inconvenient design.

Additionally, a circularly polarized antenna having a transmission line coupled to a signal is disclosed by well-known documents. However, an antenna design by a technique in accordance with the well-known documents is sensitive because of errors of up and down electrode accuracy such that impedance matching of the antenna easily varies. Radiation efficiency of the antenna is effected by its metal plane having an enclosed route such that gain of the antenna is lower than traditional ceramic antenna with 3 dBi˜5 dBi.

### SUMMARY OF THE INVENTION

The present disclosure provides a circularly polarized antenna comprising: a substrate having a top surface for a radiation metal sheet to be disposed thereon, and an opposite bottom surface for a ground metal sheet to be disposed thereon; and a metal microstrip comprising a first metal microstrip segment disposed on a near corner region of the top surface of the substrate where the radiation metal sheet is not disposed, a second metal microstrip segment disposed on a near corner region of the bottom surface of the substrate where the ground metal sheet is not disposed, and a third metal microstrip segment disposed on a side wall of the substrate and electrically connected to the first metal microstrip segment and the second metal microstrip segment, wherein the first metal microstrip segment, the second metal microstrip segment, and the third metal microstrip segment are respectively disposed on corresponding locations of different planes at a corner of the substrate so as to form an integral three-section bended member.

Moreover, the present disclosure further provides a manufacturing method of a circularly polarized antenna, comprising: providing a substrate, disposing a radiation metal sheet and a ground metal sheet on a top surface and a bottom surface of the substrate, respectively, disposing a first metal microstrip segment on a corner region of the top surface of the substrate where the radiation metal sheet is not disposed, disposing a second metal microstrip segment on a corner region of the bottom surface of the substrate where the ground metal sheet is not disposed, disposing on a side wall of the substrate a third metal microstrip segment electrically connected to the first metal microstrip segment and the second metal microstrip segment, providing a system ground unit and a signal-fed component, connecting one end of the signal-fed component to the system ground unit, connecting the other end of the signal-fed component to the second metal microstrip segment, and regulating dimensions and locations of the radiation metal sheet, the ground metal sheet, the second metal microstrip segment and/or the first metal microstrip segment so as to optimize signal characteristic of the circularly polarized antenna.

### BRIEF DESCRIPTION OF DRAWINGS

The disclosure can be more fully understood by reading the following detailed description of the preferred embodiments, with reference made to the accompanying drawings, wherein:

FIG. 1 is a schematic diagram of a circularly polarized antenna in accordance with the present disclosure;

FIG. 2A is a perspective view of the circularly polarized antenna of FIG. 1 in accordance with an embodiment;

FIG. 2B is a perspective view of the circularly polarized antenna of FIG. 1 in accordance with an embodiment;

FIG. 3A shows a top surface of the circularly polarized antenna of FIG. 2A;

FIG. 3B shows a side wall of the circularly polarized antenna of FIG. 2A;

FIG. 3C shows a bottom surface of the circularly polarized antenna of FIG. 2A;

FIG. 4A shows a top surface of the circularly polarized antenna in accordance with an embodiment of the present disclosure;

FIG. 4B shows a top surface of the circularly polarized antenna in accordance with another embodiment of the present disclosure;

FIG. 4C shows a bottom surface of the circularly polarized antenna in accordance with an embodiment of the present disclosure;

FIG. 4D shows a bottom surface of the circularly polarized antenna in accordance with another embodiment of the present disclosure;

FIG. 5 is an actual measuring data diagram of return loss in accordance with the circularly polarized antenna of the present disclosure;

FIG. 6 is a Smith chart of an experimental result in accordance with the circularly polarized antenna of the present disclosure;

FIG. 7 is an X-Z plane diagram in radiated form of an experimental result in accordance with the circularly polarized antenna of the present disclosure;

FIG. 8 is an antenna axial ratio diagram of an experimental result in operation bandwidth in accordance with the circularly polarized antenna of the present disclosure; and

FIG. 9 is a flow chart of a manufacturing method in accordance with the circularly polarized antenna of the present disclosure.

### DETAILED DESCRIPTION OF PREFERRED EMBODIMENTS

The following illustrative embodiments are provided to illustrate the disclosure of the present disclosure, these and other advantages and effects can be apparently understood by those in the art after reading the disclosure of this specification. The present disclosure can also be performed or applied by other different embodiments.

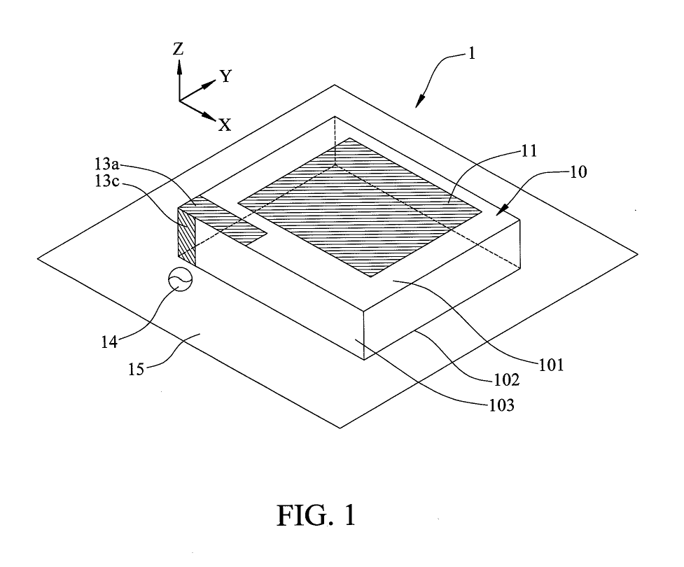

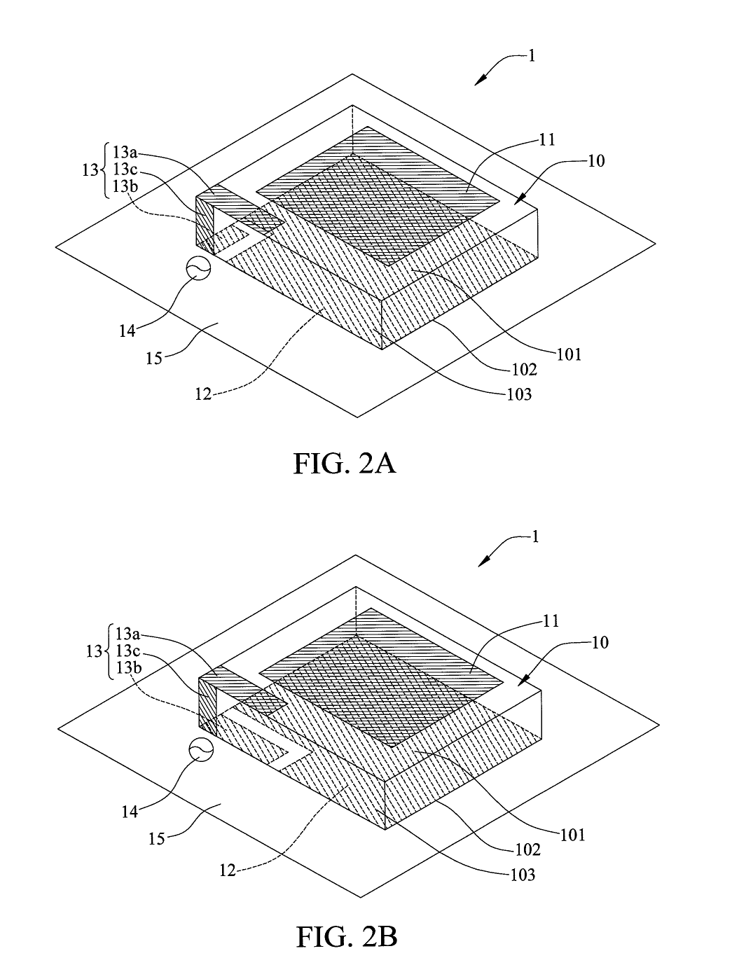

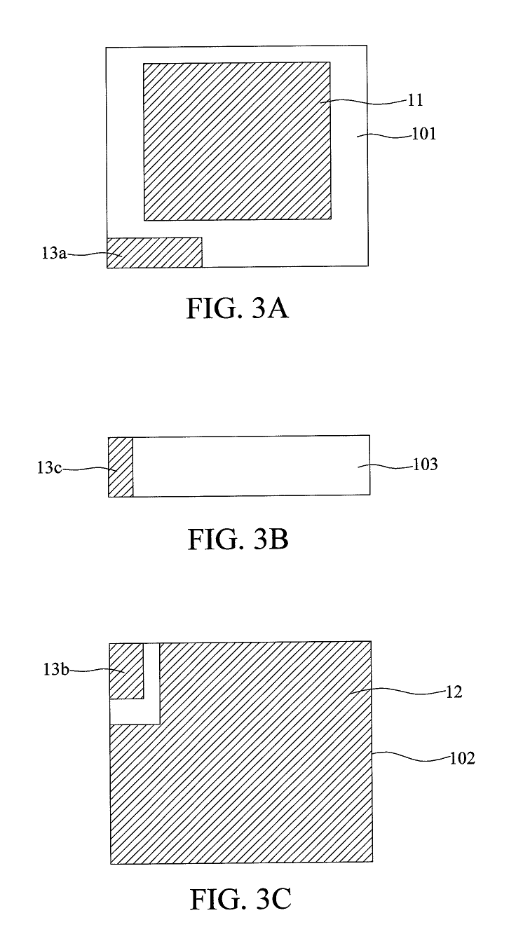

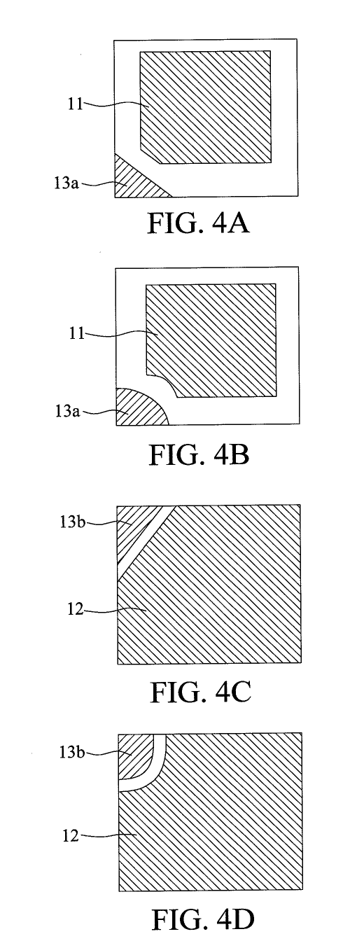

Please refer to FIG. 1, FIG. 2A, FIG. 2B, FIG. 3A, FIG. 3B, FIG. 3C, FIG. 4A, FIG. 4B, FIG. 4C, and FIG. 4D in order to clearly illustrate a circularly polarized antenna of the present disclosure. FIG. 1 is a schematic diagram of the circularly polarized antenna in accordance with the present disclosure. FIG. 2A and FIG. 2B are perspective views of the circularly polarized antenna of FIG. 1 in different embodiments. FIG. 3A˜FIG. 3C are schematic plane drawings of the circularly polarized antenna of FIG. 2A in different planes. FIG. 4A˜FIG. 4D are schematic plane drawings of the circularly polarized antenna in accordance with different embodiments of the present disclosure.

As illustrated, the circularly polarized antenna 1 comprises a substrate 10, a radiation metal sheet 11, a ground metal sheet 12, a metal microstrip 13 comprising a first metal microstrip segment 13a, a second metal microstrip segment 13b, and a third metal microstrip segment 13c, and, according to actual demand, a signal-fed component 14 and a system ground unit 15 which may be provided or not.

The substrate 10 may be a microwave dielectric substrate which is monolithic structure having a dielectric constant of about 60. The substrate 10 may be in a shape of a triangular cylinder, rectangular cylinder, circular cylinder, or elliptical cylinder, and may comprise glass fiber, FR4 and/or ceramics.

The radiation metal sheet 11 is disposed on a portion of a top surface 101 of the substrate 10. In the embodiment, the radiation metal sheet 11 is disposed on a central region of the top surface 101 of the substrate 10 and may be a metal sheet in a shape of a circle, ellipse, triangle, rectangle, or polygon, as illustrated in FIG. 4A and FIG. 4B, so as to provide frequency responses of the antenna in different range and impedance matching.

The ground metal sheet 12 is disposed on a portion of a bottom surface 102 of the substrate 10. In the embodiment, the portion does not include a near corner region of the bottom surface 102 where is not covered by the ground metal sheet 12 and may be rectangular as illustrated in FIG. 3C, triangular as illustrated in FIG. 4C, or approximately curved as illustrated in FIG. 4D.

The first metal microstrip segment 13a is disposed on a near corner region of the top surface 101 of the substrate 10 where the radiation metal sheet 11 is not disposed and is not electrically connected with the radiation metal sheet 11 directly. In the embodiment, the first metal microstrip segment 13a may be rectangular form as illustrated in FIG. 3A, triangular as illustrated in FIG. 4A, or approximately curved as illustrated in FIG. 4B.

The second metal microstrip segment 13b is disposed on a near corner region of the bottom surface 102 of the substrate 10 where the ground metal sheet 12 is not dispose. Accordingly, the second metal microstrip segment 13b is not covered by the ground metal sheet 12 and is not electrically connected with the ground metal sheet 12 directly. In the embodiment, the second metal microstrip segment 13b may be rectangular as illustrated in FIG. 3C, triangular as illustrated in FIG. 4C, or approximately curved as illustrated in FIG. 4D.

The third metal microstrip segment 13c is disposed on a side wall 103 of the substrate 10 and is electrically connected with the first metal microstrip segment 13a and the second metal micro strip segment 13b directly. In the embodiment, since the third metal microstrip segment 13c is disposed on the side wall 103 of the substrate 10 close to edges of the first metal microstrip segment 13a and the second metal microstrip segment 13b, the first metal microstrip segment 13a, the second metal microstrip segment 13b, and the third metal microstrip segment 13c are disposed on corresponding locations of three different planes at the same corner of the substrate 10, respectively, and form an integral three-section bended member, as illustrated in FIGS. 2A and 2B for right-hand circular polarization (RHCP) and left-hand circular polarization (LHCP), respectively.

The signal-fed component 14 has one end connected to the system ground unit 15, and the other end connected to the second metal microstrip segment 13b. In the embodiment, the signal-fed component 14 may input an electrical signal to the metal microstrip 13 such that the metal microstrip 13 couples an electromagnetic signal to the ground metal sheet 12 and the first metal microstrip segment 13a couples an electromagnetic signal to the radiation metal sheet 11. The signal-fed component 14 may be a coaxial line, a coplanar line, or a SMA joint. Therefore, any point of the second metal microstrip segment 13b may be considered as a signal-fed terminal (positive terminal) of the circularly polarized antenna 1 in accordance with the present disclosure. Additionally, the system ground unit 15 may be connected to the substrate 10 by Surface Mount Technique (SMT), wherein the system ground unit 15 may be a conductive metal structure in the shape of a rectangle, possibly a metal structure in a shape of a circle, ellipse, triangle, rectangle, or polygon.

Hence, the circularly polarized antenna of the present disclosure may generate a circularly polarized signal in levorotation or dextrorotation by an electromagnetic signal coupling effect between the radiation metal sheet 11 and the first metal microstrip segment 13a and another electromagnetic signal coupling effect between the ground metal sheet 11 and the first metal microstrip segment 13a. In actual implementation, the circularly polarized antenna may generate two resonance modes with the same amplitude and phase difference of 90 degrees to achieve antenna design of circular polarization and adaptive impedance matching. Since the circularly polarized antenna 1 of the present disclosure may use any point of the second metal microstrip segment 13b to be a signal-fed terminal, impedance matching of a traditional side-fed antenna easily interacted with surrounding environment could be avoided so as to increase overall reliability and stability.

It should be noted that the circularly polarized antenna 1 of the present disclosure may also control a circularly polarized signal in levorotation and a circularly polarized signal in dextrorotation under consideration of not changing the signal-fed point (any point of the second metal microstrip segment 13b) via regulating a corresponding angle of the first metal microstrip segment 13a with related to the second metal microstrip segment 13b, for instance, forming the corresponding angle of the first metal microstrip segment 13a in rectangular form with related to the second metal microstrip segment 13b to be 90 degree (that is, the first metal microstrip segment 13a is lengthwise perpendicular to the second metal microstrip segment 13b, as illustrated in FIG. 2A) or 180 degree (that is, the first metal microstrip segment 13a is lengthwise parallel to the second metal microstrip segment 13b, as illustrated in FIG. 2B) so as to respectively generate the circularly polarized signal in levorotation and the circularly polarized signal in dextrorotation, thereby increasing convenience of design.

Next, the circularly polarized antenna 1 of the present disclosure also may control the circularly polarized signal in levorotation and the circularly polarized signal in dextrorotation and may optimize signal characteristic simultaneously under consideration of not changing the signal-fed point via regulating dimension and location between the first metal microstrip segment 13a and the radiation metal sheet 11 and/or dimension and location between the second metal microstrip segment 13b and the ground metal sheet 12. For example, the circularly polarized signal in levorotation or dextrorotation may be generated and signal characteristic is simultaneously optimized by regulating distance between the first metal microstrip segment 13a and the radiation metal sheet 11 and/or a distance between the second metal microstrip segment 13b and the ground metal sheet 12 through regulating width, shape, or wind of the first metal microstrip segment 13a and/or the second metal microstrip segment 13b when the angle of the first metal microstrip segment 13a with related to the second metal microstrip segment 13b is not specific so as to achieve customization and optimization.

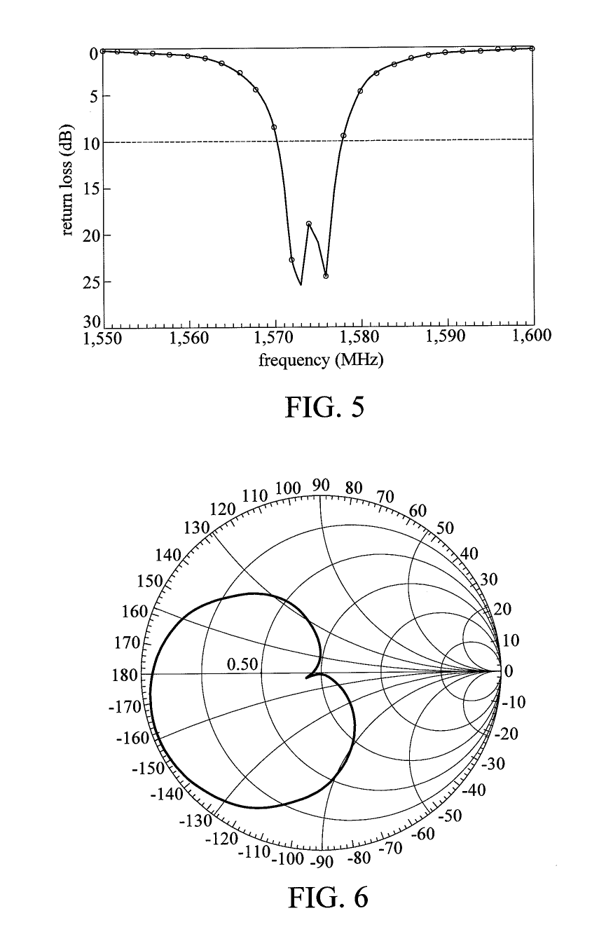

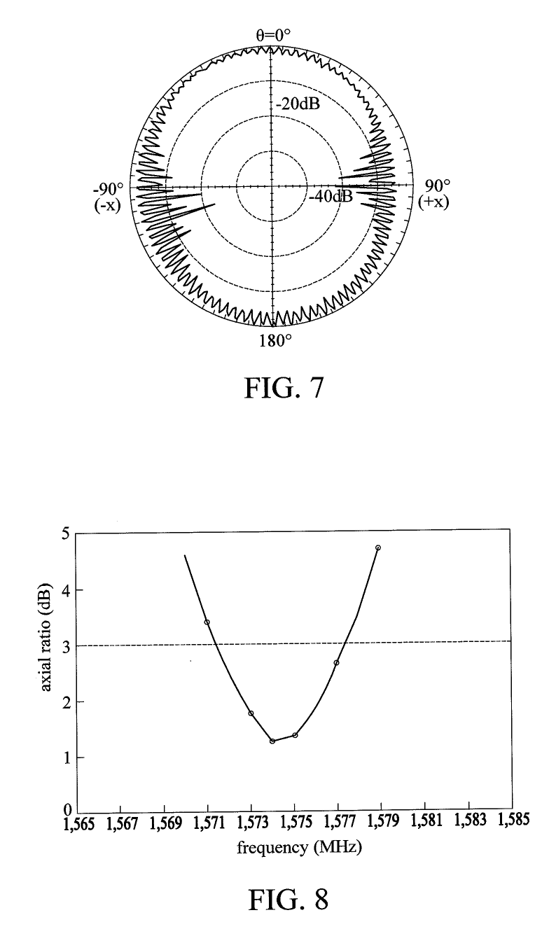

Please refer to FIG. 5˜FIG. 8 in order to explain actual measuring result of the circularly polarized antenna 1 in accordance with the present disclosure. FIG. 5 is an actual measuring data diagram of return loss in accordance with the circularly polarized antenna 1 of the present disclosure showing that impedance bandwidth of the circularly polarized antenna 1 in accordance with the present disclosure at 10 dB in return loss is approximate 8˜10 MHz. FIG. 6 is a Smith chart of experimental result in accordance with the circularly polarized antenna 1 of the present disclosure showing that impedance of the circularly polarized antenna 1 in accordance with the present disclosure at central frequency is approximate 50 ohms. FIG. 7 is an X-Z plane diagram in radiated form of experimental result in accordance with the circularly polarized antenna 1 of the present disclosure showing that the circularly polarized antenna 1 of the present disclosure has good axial ratio performance and directivity in zenith direction. FIG. 8 is an antenna axial ratio diagram of experimental result in operation bandwidth in accordance with the circularly polarized antenna 1 of the present disclosure showing that circularly polarized benefit in axial ratio bandwidth of 3 dB is approximate 2˜3 MHz. Therefore, the circularly polarized antenna 1 of the present disclosure has high reliability and is not easily disturbed by environment.

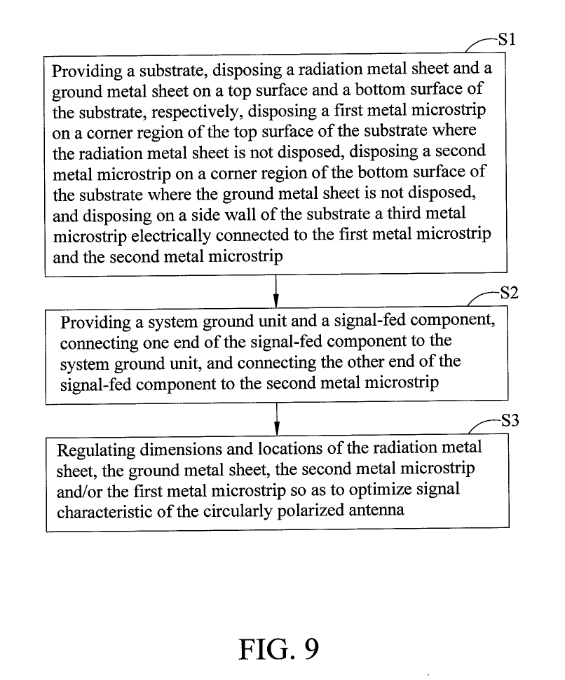

Please refer to FIG. 9 showing a flow chart in conjunction with previously described FIG. 1˜FIG. 2B, in which a manufacturing method of the circularly polarized antenna 1 in accordance with the present disclosure is clearly explained.

Step S1 comprises providing the substrate 10, disposing the radiation metal sheet 11 and the ground metal sheet 12 on the top surface 101 and bottom surface 102 of the substrate 10, respectively, disposing the first metal microstrip segment 13a on the corner region of the top surface 101 of the substrate 10 where the radiation metal sheet 11 is not disposed, disposing the second metal microstrip segment 13b on the corner region of the bottom surface 102 of the substrate 10 where the ground metal sheet 12 is not disposed, and disposing on the side wall 103 of the substrate 10 the third metal microstrip segment 13c electrically connected to the first metal microstrip segment 13a and the second metal microstrip segment 13b. Proceed to step S2.

It should be noted that, in the embodiment, the first metal microstrip segment 13a, the second metal microstrip segment 13b, and the third metal microstrip segment 13c are disposed on corresponding locations of three different planes at the same corner of the substrate 10, respectively, and form an integral three-section bended member. Step S1 further comprises forming the corresponding angle of the first metal microstrip segment 13a with related to the second metal microstrip segment 13b to be 90 degree or 180 degree if the first metal microstrip segment 13a and the second metal microstrip segment 13b are all rectangles. Disposing the radiation metal sheet 11 on the top surface 101 of the substrate 10 means disposing the radiation metal sheet 11 on a central region of the top surface 101 of the substrate 10 via thick film stencil printing technology, developing etch, and/or plasma deposition techniques.

Step S2 comprises providing the system ground unit 15 and the signal-fed component 14, connecting one end of the signal-fed component 14 to the system ground unit 15, and connecting the other end of the signal-fed component 14 to the second metal microstrip segment 13b. Proceed to step S3.

It should be noted that, the signal-fed component 14 could transits a electrical signal into the second metal microstrip segment 13b, such that the second metal microstrip segment 13b is coupled with the ground metal sheet 12, and the first metal microstrip segment 13a is coupled with the radiation metal sheet 11 by the signal.

Step S3 comprises regulating dimensions and locations of the radiation metal sheet 11, the ground metal sheet 12, the first metal microstrip segment 13a and/or the second metal microstrip segment 13b so as to optimize signal characteristic of the circularly polarized antenna 1.

It should be noted that step S3 further comprises regulating the angle of the first metal microstrip segment 13a with related to the second metal microstrip segment 13b to be 90 degree or 180 degree so as to generate circularly polarized signal characteristic in levorotation or dextrorotation if the first metal microstrip segment 13a and the second metal microstrip segment 13b are all rectangles. Of course, step S3 further comprises regulating lengths and widths of the first metal microstrip segment 13a and the second metal microstrip segment 13b if the first metal microstrip segment 13a and the second metal microstrip segment 13b are in curved form or other forms having no specific angle.

In conclusion, the present disclosure provides a circularly polarized antenna and a manufacturing method thereof, which may achieve circularly polarized signal characteristic respectively in levorotation or dextrorotation without changing a signal-fed point. Impedance matching of the circularly polarized antenna and its manufacturing method is not easily disturbed by surrounding environment so as to increase reliability of the antenna. The circularly polarized antenna and its manufacturing method may benefit to massive and rapid assembly and manufacture and effectively decrease overall thickness of products.

In other words, the circularly polarized antenna and its manufacturing method of the present disclosure not only effectively decrease overall thickness of products but also benefit to massive and rapid assembly and manufacture according to simple structure and characteristic of no protruding electrical pin. Meanwhile, since any point of the second metal microstrip segment may be considered as the signal-fed point, control of circularly polarized signal in levorotation or dextrorotation may be achieved conveniently under consideration of unnecessarily changing the signal-fed point so as to provide convenient design. Furthermore, since the signal-fed point of the circularly polarized antenna in accordance with the present disclosure is not located on exposed side, impedance matching of the antenna disturbed by surrounding environment is avoided for increasing reliability and stability of products.

The foregoing descriptions of the detailed embodiments are only illustrated to disclose the features and functions of the present disclosure and not restrictive of the scope of the present disclosure. It should be understood to those in the art that all modifications and variations according to the spirit and principle in the disclosure of the present disclosure should fall within the scope of the appended claims.

What is claimed is:

1. A circularly polarized antenna, comprising:
a substrate having a top surface for a radiation metal sheet to be disposed thereon, and an opposite bottom surface for a ground metal sheet to be disposed thereon; and
a metal microstrip, comprising:
a first metal microstrip segment disposed on a near corner region of the top surface of the substrate where the radiation metal sheet is not disposed;
a second metal microstrip segment disposed on a near corner region of the bottom surface of the substrate where the ground metal sheet is not disposed; and
a third metal micro strip segment disposed on a side wall of the substrate and electrically connected to the first metal microstrip segment and the second metal microstrip segment,
wherein the first metal microstrip segment, the second metal microstrip segment, and the third metal microstrip segment are disposed on corresponding locations of different planes at a same corner of the substrate so as to form an integral three-section bended member.

2. The circularly polarized antenna of claim 1, further comprising a system ground unit and a signal-fed component, the signal-fed component having one end connected to the system ground unit, and the other end connected to the second metal microstrip segment.

3. The circularly polarized antenna of claim 2, wherein the signal-fed component inputs an electrical signal into the second metal microstrip segment such that the second metal microstrip segment couples a signal to the ground metal sheet and the first metal microstrip segment couples a signal to the radiation metal sheet.

4. The circularly polarized antenna of claim 2, wherein the substrate is connected to the system ground unit by a surface mount technique (SMT).

5. The circularly polarized antenna of claim 2, wherein the signal-fed component is a coaxial line, a coplanar line, or an SMA joint.

6. The circularly polarized antenna of claim 1, wherein the substrate is a microwave dielectric substrate.

7. The circularly polarized antenna of claim 1, wherein the radiation metal sheet is disposed on a central region of the top surface of the substrate and is in a shape of a circle, an ellipse, or a triangle.

8. The circularly polarized antenna of claim 1, wherein the near corner of the bottom surface of the substrate is in a shape of a triangle, rectangle, or an arc.

9. The circularly polarized antenna of claim 1, wherein the first metal micro strip segment and the second metal microstrip segment are in a shape of a triangle, rectangle, or an arc.

10. The circularly polarized antenna of claim 1, wherein the first metal microstrip segment and the second metal microstrip segment are in a shape of a rectangle, and are lengthwise parallel or lengthwise perpendicular to each other.

11. A manufacturing method of a circularly polarized antenna, comprising:
providing a substrate and disposing a radiation metal sheet and a ground metal sheet on a top surface and a bottom surface of the substrate respectively, wherein a first metal microstrip segment is disposed on a corner region of the top surface of the substrate where the radiation metal sheet is not disposed, a second metal microstrip segment is disposed on a corner region of the bottom surface of the substrate where the ground metal sheet is not disposed, and a third metal microstrip segment is disposed on a side wall of the substrate and electrically connected to the first metal microstrip segment and the second metal microstrip segment; and
providing a system ground unit and a signal-fed component, and connecting one end of the signal-fed component to the system ground unit, and the other end of the signal-fed component to the second metal microstrip segment.

12. The manufacturing method of claim 11, wherein the first metal microstrip segment, the second metal microstrip segment, and the third metal microstrip segment are disposed on corresponding locations of three planes at a same corner of the substrate so as to form an integral three-section bended member.

13. The manufacturing method of claim 11, wherein the signal-fed component inputs an electrical signal into the second metal microstrip segment such that the second metal microstrip segment couples a signal to the ground metal sheet and the first metal microstrip segment couples a signal to the radiation metal sheet.

14. The manufacturing method of claim 11, further comprising making the first metal microstrip segment to be lengthwise perpendicular or lengthwise parallel to the second metal microstrip segment so as to generate circularly polarized signal characteristics in levorotation or dextrorotation.

15. The manufacturing method of claim 11, further comprising regulating a distance between the radiation metal sheet and the first metal microstrip segment and regulating another distance between the ground metal sheet and the second metal microstrip segment.

16. The manufacturing method of claim 11, wherein further comprising regulating lengths and widths of the first metal micro strip segment and the second metal microstrip segment.

17. The manufacturing method of claim 11, wherein the radiation metal sheet is disposed on a central region of the top surface of the substrate via thick film stencil printing, developing etch, and/or plasma deposition techniques.
